(19) United States
(12) Patent Application Publication
(10) Pub. No.: US 2018/0283616 A1
(43) Pub. Date: Oct. 4, 2018

(54) LOADING SYSTEM AND METHOD OF USE THEREOF

(71) Applicant: ROSKA DBO INC., Grande Prairie (CA)

(72) Inventors: Clayton Roska, Grande Prairie (CA); Duane Edward Weiser, Grande Prairie (CA); Ronald Michael Kowalyk, Grande Prairie (CA); Gregory Thomas Nesom, High River (CA); Terry Wesley Quackenbush, Grande Prairie (CA); Clinton Kent Rowland, Grande Prairie (CA); Thomas Daniel Eidt, Edson (CA); Kelly Murray Gitzel, Grande Prairie (CA); Connor John Martin, Grande Prairie (CA); Curtis A. Moore, Grande Prairie (CA); Stephen Michael LaFond, Wembley (CA)

(21) Appl. No.: 15/936,733

(22) Filed: Mar. 27, 2018

Related U.S. Application Data
(60) Provisional application No. 62/479,912, filed on Mar. 31, 2017.

(51) Int. Cl. F17C 13/12; F17C 5/02; F17C 13/04

(52) U.S. Cl. CPC F17C 13/126; F17C 5/02; F17C 13/04; F17C 2270/0171; F17C 2250/0636; F17C 2227/044; F17C 2250/0689; F17C 2260/044; F17C 2260/035; F17C 2221/033; F17C 2250/0626

(57) ABSTRACT

A system is provided for loading one or more transport tank. The system comprises one or more load lines for connecting between on-site storage tanks or vessels and the transport tanks; one or more vapour return lines for connecting between the transport tanks and an on-site flare or downstream units; an oxygen deficient medium source; one or more oxygen deficient medium blend supply lines connectable to each of the vapour return lines; a HMI/PLC for automation and control of the operations of the system; and a control panel in communication with the HMI/PLC for starting and stopping operation of the system. Gases displaced from the transport tanks during loading can be sent directly to flare or downstream units. A method is provided for loading a fluid from one or more on-site storage tanks or vessels to one or more transportation tanks in which gases displaced from the transport tank during loading are sent directly to flare or downstream units; and the method is automatically monitored and controlled via an HMI/PLC.

### FIELD OF THE INVENTION

The present invention relates to an automated system for safe loading of transportation tanks for carrying hydrocarbons, hydrocarbon by-products and other volatile fluids, and for methods of using the same.

### BACKGROUND OF THE INVENTION

During loading of hydrocarbons, hydrocarbon by-products or other volatile or hazardous fluids from onsite storage to a transport tank, there is always a displacement of the gaseous environment from inside the transport tank as it is getting filled. In the case of volatile fluids, there is also off-gassing, or the release of vapours off of the volatile fluid.

As fluids are loaded, these gaseous vapors, be they displaced vapours or off-gassing vapours, are typically released from the vent system on the transport tank. Typically, in industry practice, where such gas is “sweet” (for example, containing less than 5 ppm hydrogen sulfide) venting to atmosphere has been permitted by industry and regulatory agencies. In the case of systems with “sour” gas (for example, containing greater than 5 ppm hydrogen sulfide), vented gas vapors have been traditionally directed to sweetening or scrubbing units.

With the industry norms as described above there are inherent dangers and issues:
1. During loading, explosive, flammable and hazardous gases are released into the atmosphere from the transportation tank or scrubber vent;
2. The gases being released in loading can create a localized oxygen deficient atmosphere, which is a hazardous condition for workers onsite;
3. Odour complaints from adjacent land owners;

While tank gases could be flared to deal with the above issues, transportation tanks arriving on site with oxygen present cannot be safely connected to a flare or vapour recovery unit due to potential explosive conditions.

Furthermore, in the case of on-site sweetening units, there can be hazards related to the disposal of the rich sweetening chemicals once spent. There are further concerns with hazardous, hydrogen sulphide atmospheres being created and/or production outages when the sweetening chemicals are spent at inopportune times, or prematurely.

For the purposes of the present invention transport tanks are intended to include any mobile tank systems such as, for example, tank trucks, tank trailers or rail cars or pressurized floating containers.

CA Patent Appl. No. 2,349,349 is directed to a method and apparatus for evacuating a section of a natural gas pipeline, but does not address fluids loading or unloading and the need for dealing with gas emissions during such processes. U.S. Pat. No. 8,480,812 teaches a process for removing hydrocarbon contaminants and noxious gases from catalytic reactors in the vapour phase without using steam. U.S. Patent Application No. 2010/0000252 is directed to a process for the loading, processing and conditioning of raw production gas, the production of compressed gas liquids and the storage, transport and delivery of pipeline quality gas and other products to market. However, it does not relate to a system for transport tank loading or unloading. U.S. Pat. No. 6,901,941 is directed to a vessel for the storage and transportation of bulk volumes of fluid and methods for using the same. U.S. Pat. No. 7,252,700 is directed to a method and mobile system for cleaning dirty gas from a newly stimulated gas well.

There is a need therefore to develop improved safe, loading systems and operational methods that can deal with vapour emissions from transport tanks.

### SUMMARY

A system is provided for loading a transport tank. The system comprises one or more load lines for connecting between on-site storage tanks or vessels and the transport tanks; one or more vapour return lines for connecting between the transport tanks and any one or more of atmosphere, a scrubber and an on-site flare or downstream units; a scrubber connectable to the one or more vapour lines and to atmosphere; an oxygen deficient medium source; one or more oxygen deficient medium purge supply lines connectable to each of the load lines for purging of the transport tank prior to loading; a HMI/PLC for automation and control of the operations of the system; and a control panel in communication with the HMI/PLC for starting and stopping operation of the system. Gases displaced from the transport tanks during loading can be sent directly to flare or downstream units.

A method is further provided for loading a fluid from one or more on-site storage tanks or vessels to one or more transport tanks. The method involves the steps of providing a loading system comprising a source of oxygen deficient medium, one or more vapour return lines to flare or downstream units and a central HMI/PLC; purging the transport tank with oxygen deficient medium prior to loading; loading the transport tank with fluid; sending gases displaced from the transport tank during loading directly to flare or downstream units; and automatically monitoring and controlling of the operations of the system via the HMI/PLC.

A further system is provided for loading one or more transport tank. The system comprises one or more load lines for connecting between on-site storage tanks or vessels and the transport tanks; one or more vapour return lines for connecting between the transport tanks and an on-site flare or downstream units; an oxygen deficient medium source; one or more oxygen deficient medium blend supply lines connectable to each of the vapour return lines; a HMI/PLC for automation and control of the operations of the system; and a control panel in communication with the HMI/PLC for starting and stopping operation of the system. Gases displaced from the transport tanks during loading can be sent directly to flare or downstream units.

A further method is provided for loading a fluid from one or more on-site storage tanks or vessels to one or more transportation tanks. The method involves the steps of providing a loading system comprising one or more load lines connectable between the storage tanks or vessels and the transportation tanks, one or more vapour return lines connectable between the transportation tanks and a flare, a source oxygen deficient medium connectable to the one or more vapour return lines; and a central HMI/PLC; loading the transport tank with fluid; blending the vapour return lines with oxygen deficient medium; sending gases displaced from the transport tank during loading directly to flare or downstream units; and automatically monitoring and controlling of the operations of the system via the HMI/PLC.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

A further, detailed, description of the invention, briefly described above, will follow by reference to the following drawings of specific embodiments of the invention. The drawings depict only typical embodiments of the invention and are therefore not to be considered limiting of its scope. In the drawings:

FIG. 1 is a schematic diagram of a first embodiment of the present system, as connected to on-site storage tanks or vessels and to a transport tank;

FIG. 2 is a schematic diagram of a second embodiment of the system of the present invention, as connected to on-site storage tanks or vessels and to a transport tank;

FIG. 3 is a schematic diagram of a third embodiment of a system of the present invention, as connected to on-site storage tanks or vessels and to a transport tank; and

FIG. 4 is a schematic diagram of a fourth embodiment of a system of the present invention, as connected to on-site storage tanks or vessels and to a transport tank.

The drawings are not necessarily to scale and in some instances proportions may have been exaggerated in order more clearly to depict certain features.

### DETAILED DESCRIPTION OF VARIOUS EMBODIMENTS

The description that follows and the embodiments described therein are provided by way of illustration of an example, or examples, of particular embodiments of the principles of various aspects of the present invention. These examples are provided for the purposes of explanation, and not of limitation, of those principles and of the invention in its various aspects.

The present safe loading system relates to safe handling of gas emissions during the fluids loading or unloading of transport tank systems such as tank trailers.

The present system can be a fixed system located on-site or it can be a portable system that can be brought to and removed from the on-site location. In a preferred embodiment, the present system is portable is more preferably skid or trailer mounted to provide portability for transportation to multiple fixed storage sites. The fluids for loading or unloading are typically sweet or sour hydrocarbons, sweet or sour hydrocarbon by-products such as produced water, although any number of further sweet or sour volatile fluids could be loaded or unloaded using the system of the present invention.

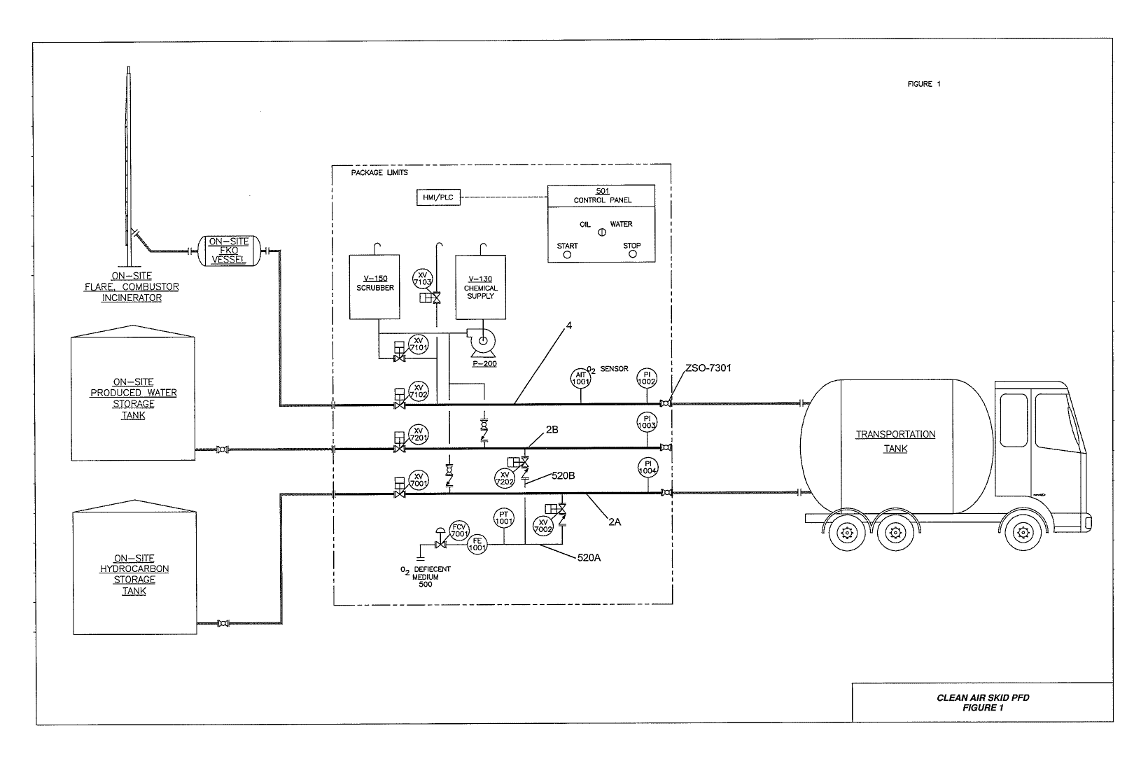

With reference to FIG. 1, a first embodiment of the system of the present invention comprises a source of oxygen deficient gas 500; a scrubber 150; one or more fluid load lines 2 for connecting between on-site storage tanks or vessels and transport tanks; one or more vapour return lines 4 for connecting between transport tanks and any one or more of a vent to atmosphere, the scrubber and an on-site flare stack; an automated human-machine interface/programmable logic controller (HMI/PLC); a plurality of valves, flow control valves, check valves, pressure indicators, flow indicators, each in communication with and controlled by the HMI/PLC; and a control panel 501 for input by the driver of the transport tank and connected to the HMI/PLC to instruct operation of the system.

The safe loading system of the present invention allows for a number of tailored loading and unloading operations to be controlled depending on such factors as fluid type, transport tank type, working conditions etc.

The present system further eliminates the practice of having a transport tank vent to atmosphere, either directly or after a sweeting process during loading or unloading. Instead, displaced gasses and off-gas vapours can be sent directly to a flare or downstream units during loading or unloading, thereby reducing vapour emissions being released in vicinity of drivers of the transport tanks, operators and any other personnel present during loading and unloading. The above goal is achieved by uniquely using the present system to purge the vapour content of the transport tank with an oxygen deficient gas medium before loading. The oxygen deficient gas, together with any off-gassing vapours displaced from the transportation tank during loading are now well below the lower explosive limit (LEL) and can then be sent directly to flare or downstream units. This also reduces the need for sour gas sweetening units on-site, since the sour gas can be flared.

The vapour content of the transport tank that is purged prior to loading can be vented to atmosphere in most cases. In the case of vapour content of the transport tank being sour or containing hydrogen sulphide, the vapour from the transportation tanks are vented through the scrubber of the system and then vented to atmosphere. In purging the vapour content of the transport tank to atmosphere, either directly or via the scrubber in sour vapour conditions, the atmosphere within the transport tank is brought down to below LEL so that during the loading process the gas and vapours displaced from the transportation tank can be directed to a flare, combustion use, pressure vessel or vapour recovery unit.

When loading sour fluid or condensate, the present system allows for vapours to be sent directly to a flare stack, or to downstream units including a vapour recovery unit, a combustion unit for energy generation or back into a pressure vessel that may optionally be provided on-site. Therefore, it is to be understood that for the purposes of the present invention, the term “flare or downstream units” used throughout this description is intended to include flare stack, a vapour recovery unit, a combustion system or a pressure vessel.

The source of oxygen deficient gas can be any source well known to those skilled in the art, and such range of sources are included in the scope of the present invention. By way of example only and without intending to be limiting, such oxygen deficient medium can include any inert gas such as nitrogen, argon, xenon, helium, carbon dioxide, natural gas or other gases that fall below the LEL such as methane etc., which can be sourced by provision of gas cylinders on the system, or from other onsite operations. The oxygen deficient medium source can be sized to meet loading capacities and rates for the transport tank to be loaded or off-loaded, or can be oversized to meet a range of transport tank volumes. More preferably, the oxygen deficient medium source can displace a rate of 1-10 m³/min to match typical rates of off-loading or loading of fluid.

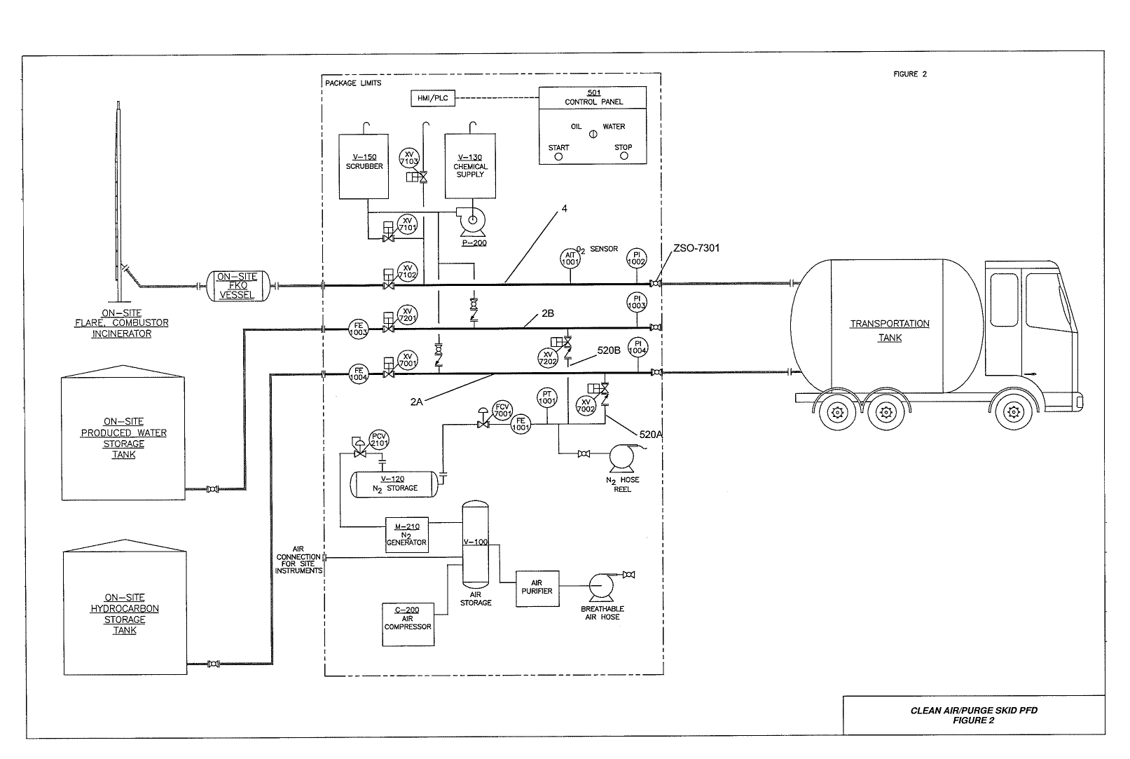

In a preferred embodiment, as illustrated in FIG. 2, the present system includes a portable nitrogen generation system for nitrogen purging the transport tank prior to loading or during unloading. In this embodiment, the nitrogen system can incorporate any number of nitrogen sources including high a pressure nitrogen bottle mounted on the system, a nitrogen generation unit mounted to the system or a nitrogen membrane package mounted to the system.

More preferably, the present nitrogen system comprises an air compressor 200 which feeds a compressed air storage vessel 100, which in turn feeds a nitrogen generation unit 210. The nitrogen generated can then be stored in a nitrogen storage vessel 120. In this embodiment, all of these units are mounted to the system of the present invention.

More preferably the flow rate and pressure of the oxygen deficient medium are monitored and regulated, more preferably to maintain oxygen deficient medium pressure within the transport tank to never exceed 175 kPa (25 psi), but to also purge the transport tank within a desired amount of time, which may be in some instances around 10 minutes.

The vapour return lines 4 of the present system have an oxygen sensor AIT 1001 to monitor the composition of gas being vented from the transport tank. The vapour return lines 4 may also include a sour gas sensor. A tee connection in the vapour return lines 4 and valving directs vented gases to any one of flare or downstream units, or to atmosphere, depending on the oxygen content detected in vented gas. In the case of sour gases, the gasses are directed to atmosphere via the scrubber. In a case where oxygen levels of the vent gas reach an explosive limit, the present system comprises controls to automatically shut down loading of the tank with fluid.

In the initial purging of the transport tank with oxygen deficient medium, the displaced gaseous contents of the tank are vented to atmosphere. In the case of vapours in the transport tank being sour, the vapours are vented to atmosphere via the scrubber that is mounted on the system. The scrubber 150 more preferably takes the form of a flooded gas scrubber unit, although any number of scrubber units could be used and would be well understood by a person of skill in the art as being included in the scope of the present invention. Vented gases are directed to atmosphere, either directly or via the scrubber, until the oxygen sensor AIT 1001 detects no more oxygen in the vapour return line 4, at which time the valve to atmosphere, and if applicable also the valve to the scrubber, is closed and the valve to the flare or downstream units opened. Further preferably, a digital display is included on the system to monitor purging to atmosphere. Most preferably, all valves for purging or displacing the volume of the tank are automated and controlled by the HMI/PLC. The valves may be air actuated valves. The vapour return lines 4 can be used for displacing transport tank volume with oxygen deficient medium during unloading.

The load lines 2A/2B comprise a pressure gauge, a purge connection 520A/520B to the oxygen deficient source 500, and valves mounted at both the connection end from the onsite storage tanks or vessels and at the connection end before the loading pump on the transport tank. It should be noted that any number of load lines 2 may be provided on the system, each possibly dedicated to a particular fluid to be loaded or unloaded. But it is also possible to have one or multiple non-dedicated load lines 2 on the system, such that more than one transport tank can be unloaded or loaded at the same time with either the same or different fluids. Oxygen deficient medium can be passed through the load lines for purging the transport tank, during which process displaced gases from the transport tank are vented to atmosphere either directly, or in the case of sour displaced gases, via the scrubber.

In a preferred embodiment, the present system may include a spent product tank 140 in connection with the scrubber, to collect spent scrubbing product from the scrubber. Any small amounts of liquids in either of the scrubber or the spent product tank can be drained by drain connections from the scrubber and the spent product tank directly into the load lines, to go out with fluids loaded into the transport tank.

In a further preferred embodiment of the present invention, a treatment product storage tank 130 connected to a product pump P-200 is preferably also mounted on the system. Such product or treatment medium can optionally be pumped into the vapour return line 4 to the scrubber, to aid in treating sour displaced gases being scrubbed prior to venting to atmosphere. Such treatment medium can include, but are not limited to sweetening chemicals, scavenging chemicals, encapsulating products, absorption products or adsorption products, although any number of other treatment medium could also be used without departing from the scope of the present invention, including the option of using no treatment medium.

In a further optional embodiment, the treatment medium can be connected to the load lines for treating at least a portion of the fluid to be loaded to the transport tank. A chemical injection line from the chemical pump may feed into the load line. For example, a sweetening chemical can be added to fluid being loaded or unloaded, to sweeten the fluid should it be sour.

The system preferably comprises the control panel 501 by which the driver of the transport tank can indicate the type of fluid being loaded or unloaded and to start or stop the process. The central HMI/PLC can be located on the system, and can be accessed locally or from a remote location from which loading and unloading can be controlled, readings taken and progress displayed.

The present system is fully automated, needing the driver to merely hook up the load lines 2 and vapour return lines 4, indicate on the control panel 501 the type of fluid being loaded and start the process, at which point the central HMI/PLC, taking input from the pressure and flow monitors, oxygen level sensors AIT 1001 and controlling the valving, automatically manages the purging, loading and/or unloading process, until the driver's transport tank level indicator indicates a full load or unload level, or the storage tank is full or empty or from a signal from the fluid metering on the present system, at which point the driver can stop the operation via the control panel. Optionally, the HMI/PLC may also have a manual override such that an operator at the HMI/PLC may remotely control the opening and closing of valves by reading the oxygen level data from the oxygen level monitors.

In a preferred method for loading fluid into a transport tank using the system of the present invention, the transport tank is first located near the system, preferably with the load pump of the truck carrying the transport tank facing the system. Next, the vent of the transport tank is connected to the vapour return lines 4 of the system. In a situation in which the system is being used for the first time at a particular site, the vapour return line 4 of the system that goes to flare or downstream units will also be connected to the on-site flare or downstream units, in other cases, this connection to flare or downstream units is already made. Again, if the system is being used for a first time, then the load lines 2 are connected to the on-site storage tank or vessel that fluid is being loaded to or from. As previously stated, the load line 2 to be connected can be a dedicated load line 2 for a particular fluid from a particular on-site storage tank or vessel, or it can be a universally usable load line. This storage tank or vessel is located on site and could include separation vessels, storage vessels etc. The other end of the load lines 2 is then connected to a load pump located on the transport tank, which in turn pumps into the transport tank.

The valve ZSO-7301 on the vapour return line 4 connected to the transport tank is opened as is the valve of the predetermined load line 2A/2B at its connection to the transport tank. Next, the valves XV-7201/XV-7001 on the load line 2A/2B to the on-site storage tanks or vessels are opened. During first site commissioning, the type of fluid being loaded is selected, typically from the options of sweet hydrocarbon, sour hydrocarbon, sweet by-product or sour by-product, which are also programmed into the HMI/PLC. The load pump is started on the transport tank and the system is started from the control panel. At this point of the present method the central HMI/PLC controls and fully automates the loading process.

The vapour return line 4 to atmosphere is opened and the oxygen deficient medium source lines 520A/520B into the load line 2A/2B is also opened and the load lines are purged by running the oxygen deficient medium through them. At this point, optionally if the dissipated vapours are sour, valves XV 7101 can be opened to direct the sour dissipated gasses to the scrubber before being vented to atmosphere. For sour dissipated vapours, if it is desired to inject a treatment medium into the vapour return line 4 into the scrubber, the chemical pump can also be started. This would more commonly be the case for sour fluid loading.

The vapour return line 4 to atmosphere and optionally also the scrubber are automatically opened and the vapour return line 4 to the flare or downstream units is automatically closed. As the displaced gases from the transport tank are purged they are directed to atmosphere, either directly or via the scrubber in sour gas circumstances, and the oxygen sensor monitors oxygen content in the vapour return line 4. When the oxygen sensor indicates a low or nil oxygen level, the transport tank has been purged and is ready for loading.

Next, the vapour return line 4 connection to flare or downstream units is now opened and the vapour return line 4 connection to atmosphere and to the scrubber is closed. In a case of sour purged gas, if treatment medium was being pumped into the vapour return line 4 that too can be stopped by stopping the chemical pump. Alternatively, if there is a desire to inject treatment medium into the load line 2A/2B to at least somewhat treat, for example, sour fluid being loaded, then the chemical pump is kept running and the valve to the load line 2A/2B opened. The load lines 2A/2B are open to allow communication between the on-site storage tank or vessel and the transport tank.

During loading, vent gas oxygen content is continually monitored. The vapour return line 4 is then opened to vent gases either to the flare or downstream units.

Once the fluid is loaded onto the tank, as indicated by a transport tank level indicator on the tank, the load line 2A/2B is shut in at its connection to the on-site storage tank or vessel and an air bleed connection is opened to allow flushing of the load line 2A/2B to vacate it of fluids. The driver stops the process via the control panel, at which point the connections to the transport tank truck are shut in.

At this point all lines are disconnected from the transport tank, and can be disconnected and open ends capped. The transport tank is now ready for transport.

While the present system has been discussed for use in the safe loading and unloading of transport tanks, there are a number of further applications for which one or more elements of the present system can be utilized and taken advantage of. The present system, providing a portable source of purge gas (that is, oxygen deficient medium) can also be transported and used at sites where purging for safe work practice is required. It can also be used in the safe primary loading of stationary vessels. Furthermore, in the particular example of the system of FIG. 2, the present system provides a portable source of air compression, nitrogen gas generation and a source of breathing air. Such connections for nitrogen and air can be seen in the N₂ hose reel and breathable air hose of FIG. 2.

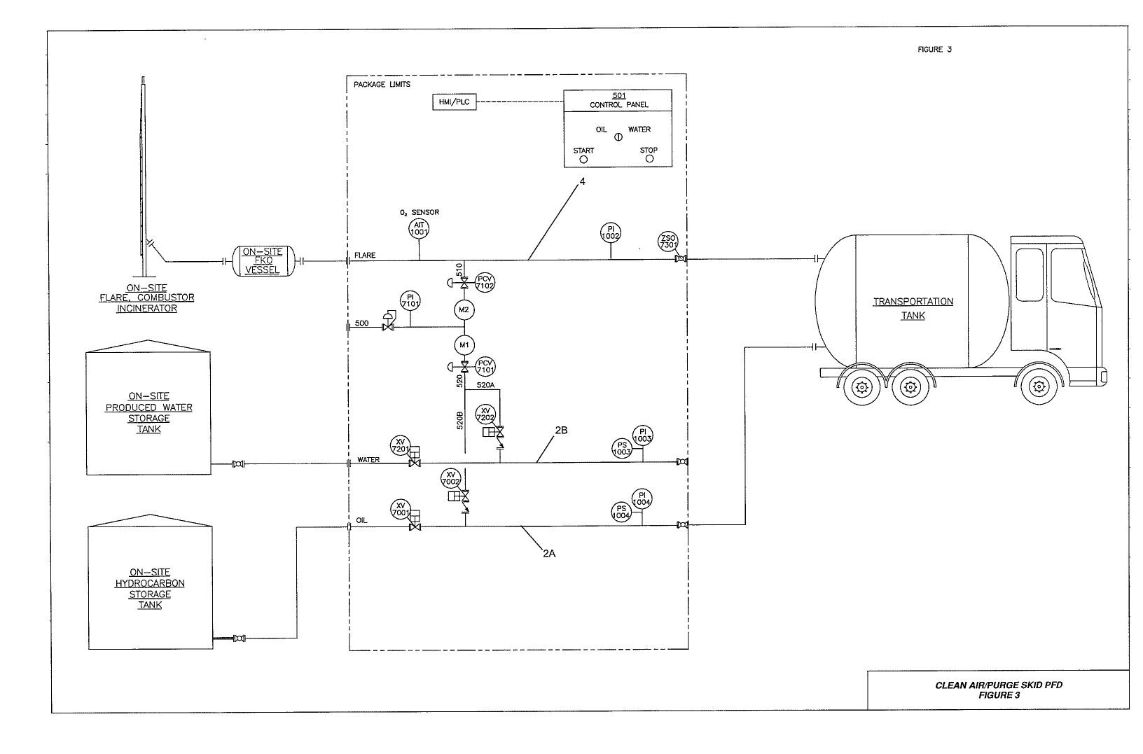

In a further embodiment of the present system, as depicted in FIG. 3, the source of oxygen deficient gas 500; is added to both the fluid load lines 2A/2B for purging the transport tanks; and is also connected to the one or more vapour return lines 4. In this embodiment, the one or more vapour return lines 4 connect directly from the transport tanks to an on-site flare stack, there is no scrubber unit and there is no venting to atmosphere.

In the embodiment of FIG. 3, purged and displaced gasses and off-gas vapours can be sent directly to a flare or downstream units, thereby reducing vapour emissions being released in vicinity of operators and any other personnel present during loading and unloading.

In this embodiment, oxygen deficient gas 500 is still used as a purge gas to purge the vapour content of the transport tank before loading. However, the oxygen deficient gas is also added as a blend gas directly to the vapour return lines 4 during purging, thereby lowering the oxygen content of the purged gas sufficiently so that it can all be flared, without sending any gas to atmosphere. In such cases the combination of oxygen deficient gas medium into the load lines 2A/2B to purge the vapour content of the transport tank, together with the blending of the displaced gasses with an oxygen deficient medium into vapour return line 4 ensures that the displaced gas is always below the LEL and can always be flared, without the need for an initial period of venting to atmosphere.

Since there is no need to initially vent to atmosphere, there is also no need to scrub vapour content of the transport tank that could be sour or contain hydrogen sulphide. Even sour or hydrogen sulfide containing vapour can be flared. Since the vapour content of the transport tank is brought down below LEL right at the start of purging, gas and vapours displaced from the transport tank during the loading process the can also continue to be directed to a flare, combustion use, pressure vessel or vapour recovery unit.

In the present embodiment when purging or loading in sour conditions, the present system allows for vapours to be sent directly to a flare stack, or to downstream units including a vapour recovery unit, a combustion unit for energy generation or back into a pressure vessel that may optionally be provided on-site. Therefore, it is to be understood that for the purposes of the present invention, the term “flare or downstream units” used throughout this description is intended to include flare stack, a vapour recovery unit, a combustion system or a pressure vessel.

With reference to FIG. 3, the oxygen deficient gas source 500 is directed via purge supply line 520 to the load lines. A meter M1 may optionally be included to monitor flow rates and control valve 7101 can control flow rates on oxygen deficient gas to the load lines. In the case of more than one storage tank being on site and more than one load line being provided on the present unit, purge supply line 520 may optionally branch to supply each load lines, as shown in FIG. 3, for example only as lines 520A and 520B. Valving on each branch of purge supply lines 520A and 5208, for example valves 7201 and 7202 on FIG. 3, can be used to direct oxygen deficient gas to the desired load line.

Oxygen deficient gas may be directed via a blend supply line 510 to the vapour return lines 4. A flow meter M2 and flow control valve 7102 may be included on blend supply line 510 to monitor and control flow of oxygen deficient gas into the vapour return line 4.

Flow of oxygen deficient gas into the vapour return line 4 is monitored and controlled to keep oxygen levels in the vapour return below the LEL. As before, an oxygen sensor AIT1001 may be included on the vapour return line 4 to monitor LEL levels.

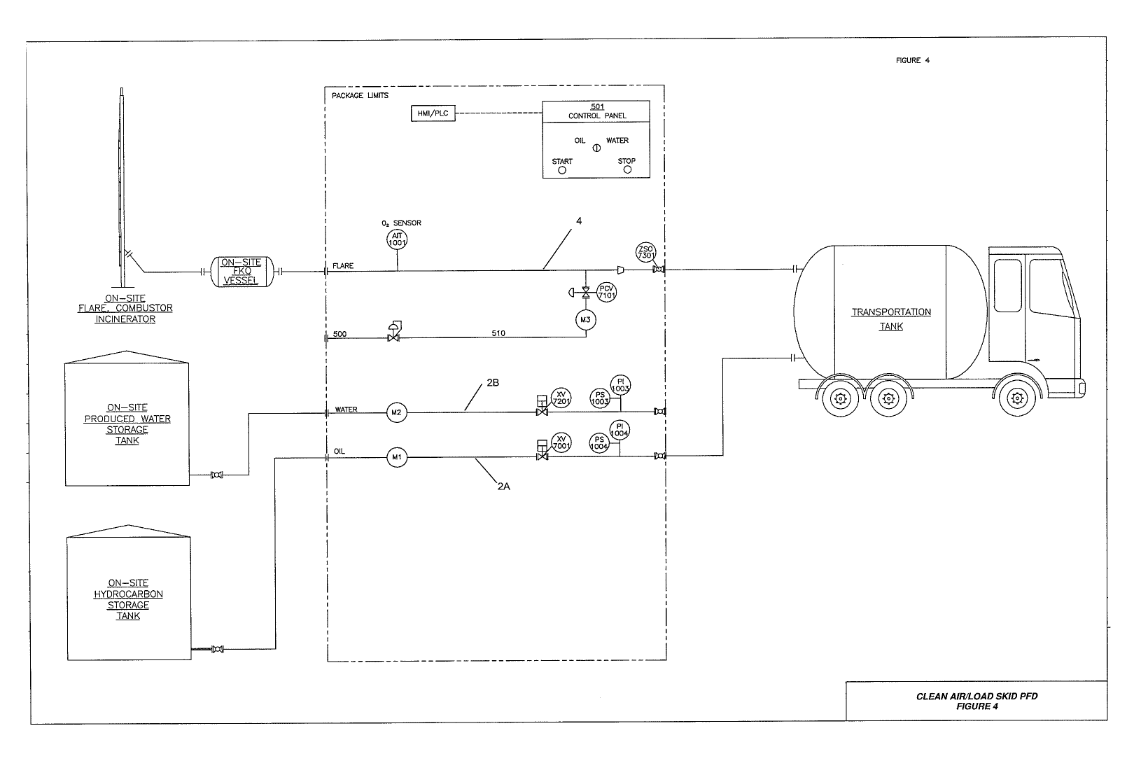

As with the systems of FIGS. 1 and 2, the system embodied in FIGS. 3 and 4 preferably comprises the control panel 501 by which the driver can indicate the type of fluid being loaded or unloaded and to start or stop the process. A separate central HMI/PLC can be located on the system, and can be accessed locally or from a remote location from which loading and unloading can be controlled, readings taken and progress displayed.

The present system is fully automated, needing the driver to merely hook up the load and vapour return lines 4, indicate on the control panel the type of fluid being loaded and start the process, at which point the central HMI/PLC, taking input from the pressure and flow monitors, oxygen level monitors and controlling the valving, automatically manages the purging, loading and/or unloading process, until the driver's transport tank level indicator indicates a full load or unload level, or the storage tank is full or empty or from a signal from the fluid metering on the present system, at which point the driver can stop the operation via the control panel.

In the system of FIG. 3, there may be a number of ways to control oxygen levels in the vapour return line. As a first example, at the start of purging the transport tank, valve 7102 on the blend supply line 510 can be set to a predetermined position to ensure a maximum oxygen deficient medium flow into the gas coming off of the purged transport tank. For example pressure in transport tank may determine the position of valve 7102. The supply of oxygen deficient medium is dependent on the content of oxygen in the transport tank vapours being purged. As such, the likely highest levels of oxygen in the transport tank vapours would occur if the transport tank vapours were mainly air, leading to an oxygen content of about 21% in the transport tank vapours. In such cases, a flow rate of oxygen deficient medium in the blend supply line 510 should be set relative to the oxygen deficient medium flow in the purge supply lines to achieve a blend that is below 8% oxygen. It would of course be understood by a person of skill in the art that the flow ratio needed to stay below LEL levels will vary based on composition of vapours being purged, flow rates, temperatures, pressures and other conditions in the vapour return lines 4.

At the beginning of purging the transportation tank, oxygen deficient medium may also be added to the load lines 2A/2B via purge supply lines 520A and 520B. The flow rate of oxygen deficient medium into the load lines 2A/2B will depend on such factors as the pressure or volume of gases in the transportation tank and the desired rate of purging the transportation tank. Valves XV7202 and XV7002 can then slowly be closed as loading begins.

While FIG. 3 shows a single source 500 of oxygen deficient medium, it would be understood by a person of skill in the art that more than one source of oxygen deficient gas may be provided on the present system. Such sources 500 might contain the same or different types of oxygen deficient gas. For example, the load lines 2A/2B may be connected to a source of nitrogen and the vapour return line 4 may be connected to a source of natural gas. As such, the system serves to purge with one type of oxygen deficient medium and blends with another.

Programming in the central HMI/PLC can preferably ensure that the desired flow ratio is maintained and can control valve 7102 to maintain the desired blend supply flow rate. The central HMI/PLC controls valve openings on the purge supply and blend supply lines 520, 510 via valves 7101 and 7102. Flowmeters M1 and M2 and oxygen sensor 1001 are used to verify the operation. The flowmeters M1 and M2 can be used to verify position of control valves 7101 and 7102, and the central HMI/PLC can make minor adjustments to each control valve opening.

Once the oxygen level in the vapour return line 4 is measured at a predetermined low, for example 3% oxygen in the vapour return line 4, it is possible to stop flow from the blend supply line 510 by closing valve 7102. At this point, oxygen deficient medium is only being supplied from the purge supply line 520.

Should for any reason there be no reading from oxygen sensor 1001, it is also possible to maintain necessary flow ratios by reading flow meters M1 and M2 and maintaining a predetermined flowrate of oxygen deficient medium to the load and vapour return lines 4.

Most preferably, all valves for purging or displacing the volume of the tank are automated. The valves may be air actuated valves. As before, the vapour return lines 4 connected with the blending supply line can be used for displacing transport tank volume with oxygen deficient medium during unloading.

More preferably, the oxygen deficient gas is natural gas as both the purge gas and the blending gas.

By removing the scrubber from the system of FIG. 3, there is no need to monitor the chemical supply to a scrubber to avoid depletion.

Typically, once the transportation tank is purged with oxygen deficient medium via purge supply lines 520A and 520B, the tank can be loaded from onside storage tanks or vessels and the displaced vapours, having satisfactorily low oxygen levels, are directed to flare. However, the HMI/PLC may also operate to open valve 7102 during the loading process, after purging, if needed, to ensure the oxygen levels stays below 8% even during a loading. In such cases, oxygen level readings are taken at oxygen sensor AIT1001 and should oxygen levels climb to a predetermined rage, valve 7102 can be opened. For example, should oxygen levels reach 6% the HMI/PLC may start up the blend supply line 510 again.

In the embodiment of FIG. 4, oxygen deficient medium is supplied only as a blend gas into the vapour return lines 4 and there is no oxygen deficient medium added to the load lines. In this embodiment, the transportation tank is not purged ahead of loading, instead the load lines 2A/2B load the transportation tank directly upon start of the process. Flow of oxygen deficient medium in the blend line 510 is maximized to lower oxygen content in the displaced gas to below 8% oxygen. Flow rate is monitored through flow meter M3 and oxygen content of the vapour return line is monitored by oxygen sensor 1001 as before.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A system for loading a transport tank, wherein said system comprises:
a. one or more load lines for connecting between on-site storage tanks or vessels and the transport tanks;
b. one or more vapour return lines for connecting between the transport tanks and any one or more of atmosphere, a scrubber and an on-site flare or downstream units;
c. a scrubber connectable to the one or more vapour lines and to atmosphere;
d. an oxygen deficient medium source;
e. one or more oxygen deficient medium purge supply lines connectable to each of the load lines for purging of the transport tank prior to loading;
f. a HMI/PLC for automation and control of the operations of the system; and
g. a control panel in communication with the HMI/PLC for starting and stopping operation of the system.
wherein gases displaced from the transport tanks during loading can be sent directly to flare or downstream units.

2. The system of claim 1, wherein said system is fixed on-site.

3. The system of claim 1, wherein said system is portable.

4. The system of claim 1, wherein the vapour return lines each further comprise an oxygen sensor, for monitoring oxygen levels in the vapour return lines.

5. The system of claim 4, wherein the purge supply lines each further comprises a flowmeter for monitoring flow of oxygen deficient medium and a control valve for controlling flow of oxygen deficient medium.

6. The system of claim 5, further comprising a source of treatment medium connected to the scrubber by a product pump, for supplying treatment medium to the scrubber for scrubbing vapours from the transport tank.

7. The system of claim 6, wherein the source of treatment medium is further connectable to the one or more vapour return lines, to treat sour displaced gases within the vapour return line before entering the scrubber.

8. The system of claim 7, wherein the treatment medium is selected from the group consisting of sweetening chemicals, scavenging chemicals, encapsulating products, absorption products and adsorption products.

9. The system of claim 7, wherein the source of treatment medium is further connectable to the one or more load lines for treating at least a portion of the fluid to be loaded to the transport tank.

10. A method for loading a fluid from one or more on-site storage tanks or vessels to one or more transport tanks, said method comprising the steps of:
a. providing a loading system comprising a source of oxygen deficient medium, one or more vapour return lines to flare or downstream units and a central HMI/PLC;
b. purging the transport tank with oxygen deficient medium prior to loading;
c. loading the transport tank with fluid;
d. sending gases displaced from the transport tank during loading directly to flare or downstream units; and
e. automatically monitoring and controlling of the operations of the system via the HMI/PLC.

11. The method of claim 7 further comprising
a. locating a transport tank near the loading system, said loading system comprising a scrubber, one or more fluid load lines for connecting between on-site storage tanks or vessels and transport tanks, and a control panel for starting and stopping operation of the system;
b. connecting at least one of said one or more vapour return lines to a vent of the transport tank;
c. connecting at least one of said one or more load lines to a load pump on the transport tank;
d. opening a valve on the vapour return line connected to the transport tank;
e. opening a valve of the load line at its connection to the transport tank;
f. opening valves on the load line at its connection to the on-site storage tank or vessel;
g. indicating type of fluid by entry into the control panel;
h. starting the load pump on the transport tank;
i. starting the system from the control panel;
j. automatically conducting via the central HMI/PLC, the steps of:
i. opening the vapour return line to atmosphere;
ii. closing the vapour return line to flare or downstream units;
iii. opening a connection between the source of oxygen deficient medium and the load line;
iv. purging the transport tank with oxygen deficient medium;
v. directing displaced gases from the transport tank to atmosphere;
vi. monitoring oxygen content in the vapour return line;
vii. when oxygen level in the vapour return line reaches a predetermined level, opening the vapour return line to flare or downstream units and closing the vapour return line to atmosphere;
viii. opening load lines to load fluid from the on-site storage tank or vessel to the transport tank.
ix. sending displaced gas from the transport tank directly to flare or downstream units;
x. at the end of loading, closing the load line connection to the on-site storage tank or vessel;
k. stopping the system via the control panel;
l. disconnecting vapour return lines and load lines from the transport tank; and
m. closing the valve connections between the vapour return line and atmosphere and the scrubber.

12. The method of claim 10, wherein said system is fixed on-site.

13. The method of claim 10, wherein said system is portable.

14. A system for loading one or more transport tank, wherein said system comprises:
a. one or more load lines for connecting between on-site storage tanks or vessels and the transport tanks;
b. one or more vapour return lines for connecting between the transport tanks and an on-site flare or downstream units;
c. an oxygen deficient medium source;
d. one or more oxygen deficient medium blend supply lines connectable to each of the vapour return lines;
e. a HMI/PLC for automation and control of the operations of the system; and
f. a control panel in communication with the HMI/PLC for starting and stopping operation of the system.
wherein gases displaced from the transport tanks during loading can be sent directly to flare or downstream units.

15. The system of claim 14, wherein the vapour return lines each further comprise an oxygen sensor located downstream of the blend supply line connection, for monitoring oxygen levels in the vapour return lines.

16. The system of claim 15, wherein the blend supply lines each further comprises a flowmeter for monitoring flow of oxygen deficient medium and a control valve for controlling flow of oxygen deficient medium.

17. The system of claim 16, wherein the oxygen deficient medium is connectable via one or more purge supply lines to each of the load lines for purging of the transport tank prior to loading.

18. They system of claim 17, wherein the purge supply lines each further comprises a flowmeter for monitoring flow of oxygen deficient medium and a control valve for controlling flow of oxygen deficient medium.

19. The system of claim 14, wherein said system is fixed on-site.

20. The system of claim 14, wherein said system is portable.

21. A method for loading a fluid from one or more on-site storage tanks or vessels to one or more transportation tanks, said method comprising the steps of:
a. providing a loading system comprising one or more load lines connectable between the storage tanks or vessels and the transportation tanks, one or more vapour return lines connectable between the transportation tanks and a flare, a source oxygen deficient medium connectable to the one or more vapour return lines; and a central HMI/PLC;
b. loading the transport tank with fluid;
c. blending the vapour return lines with oxygen deficient medium;
d. sending gases displaced from the transport tank during loading directly to flare or downstream units; and
e. automatically monitoring and controlling of the operations of the system via the HMI/PLC.

22. The method of claim 21, further comprising the steps of purging the transport tank with oxygen deficient medium via the load lines prior to loading.

23. The method of claim 22, wherein purging the transport tank further comprises:
a. connecting at least one of said one or more vapour return lines to a vapour of the transport tank;
b. connecting at least one of said one or more load lines to a load pump on the transport tank;
c. connecting a purge supply line from said source of oxygen deficient gas to the load line;
d. connecting a blend supply line from said source of oxygen deficient gas to the vapour line; and
e. flowing oxygen deficient medium through the load lines and through the vapour return lines.

24. The method of claim 23, further comprising the steps of:
a. automatically conducting via the central HMI/PLC, the steps of:
i. opening a valve on the purge supply line to the load line;
ii. opening a valve on the blend line to provide oxygen deficient medium to the vapour line;
iii. purging the transport tank with oxygen deficient medium;
iv. opening the vapour line to flare or downstream units;
v. monitoring oxygen content in the vapour line;
vi. opening load lines to load fluid from the on-site storage tank or vessel to the transport tank.
vii. at the end of loading, closing the load line connection to the on-site storage tank or vessel;
b. stopping the system via the control panel; and
c. disconnecting vapour return lines and load lines from the transport tank.

25. The method of claim 21, wherein said system is fixed on-site.

26. The method of claim 21, wherein said system is portable.
